(19) United States
(12) Patent Application Publication
(10) Pub. No.: US 2008/0102333 A1
(43) Pub. Date: May 1, 2008

(54) FUEL CELL UNIT

(75) Inventors: Daisuke Watanabe, Chigasaki-shi (JP); Taishi Hisano, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/928,150

(22) Filed: Oct. 30, 2007

(30) Foreign Application Priority Data
Oct. 31, 2006 (JP) 2006-297151

(51) Int. Cl. H01M 8/04

(52) U.S. Cl. 429/23; 429/22

(57) ABSTRACT

According to one embodiment, a fuel cell unit is provided with a unit body including an electromotive section which performs power generation operation, a fuel cartridge removably attached to the unit body and stored with a fuel, a fuel supply line through which the fuel is supplied from the fuel cartridge to the electromotive section, a fuel detecting section configured to detect a property of the fuel in the fuel supply line, and a control section which at least warns about the necessity of replacement of the fuel cartridge or stops the operation of the unit body if the property of the fuel detected by the fuel detecting section is different from a given property.

### CROSS-REFERENCE TO RELATED APPLICATIONS

This application is based upon and claims the benefit of priority from Japanese Patent Application No. 2006-297151, filed Oct. 31, 2006, the entire contents of which are incorporated herein by reference.

### BACKGROUND

1. Field

One embodiment of the present invention relates to a fuel cell unit used as a power source for an electronic device or the like.

2. Description of the Related Art

Presently, secondary batteries, such as lithium ion batteries, are mainly used as power sources for portable notebook personal computers (notebook PCs), mobile devices, etc. In recent years, small, high-output fuel cells that require no charging have been expected as new power sources to meet the demands for increased power consumption and prolonged use of these electronic devices with higher functions.

A fuel cell unit, unlike primary and secondary batteries, can extend its continuous power generation time by being filled with a fuel. The fuel cell unit of this type is provided with a fuel cell body, which includes an electromotive section, and a changeable fuel cartridge attached to the cell body. The fuel cartridge is filled with, for example, alcohol as a liquid fuel. When the fuel is used up, continuous power generation can be performed after replacing the cartridge with a new one.

In order to recognize the time for the replacement of the fuel cartridge in the fuel cell unit constructed in this manner, it is advisable to detect the residual amount of fuel in the cartridge. By detecting the residual fuel amount, the fuel cartridge can be changed after it is exhausted, and power generation operation without the fuel can be prevented.

A camera with a fuel cell and a fuel sensor unit is described in Jpn. Pat. Appln. KOKAI Publication No. 2005-172638, for example. The fuel sensor unit includes a light projecting element and a light receiving element that are arranged laterally at the lower part of a fuel reservoir. Thus, the residual fuel amount can be detected depending on whether or not light absorbed by the liquid fuel reaches the light receiving element.

As described above, alcohol or some other liquid fuel used in the fuel cell varies in type, concentration, purity, etc., depending on the form of power generation of the fuel cell. Unless the liquid fuel is appropriate for the fuel cell unit, therefore, the cell unit may fail to perform normal power generation, and besides, reduction of the power generation capacity or some failure may be caused. Further, there is a possibility of fake fuel cartridges being used that are wrongfully filled with cheap fuels. Naturally, it is desirable to prevent the use of these wrongful cartridges.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a fuel cell unit according to an embodiment of the invention;

FIG. 2 is an exemplary perspective view showing a fuel cell system provided with the fuel cell unit and an information processor;

FIG. 3 is an exemplary system diagram mainly showing the internal structure of a power generator of the fuel cell unit;

FIG. 4 is an exemplary sectional view showing a DMFC stack of the fuel cell unit;

FIG. 5 is an exemplary view schematically showing a single cell of the DMFC stack;

FIG. 6 is an exemplary diagram showing a state in which the information processor is connected to the fuel cell unit;

FIG. 7 is an exemplary diagram showing the configuration of the fuel cell unit and the information processor;

FIG. 8 is an exemplary flow chart showing operation for discriminating an appropriate fuel in the fuel cell unit;

FIG. 9 is an exemplary diagram showing the respective electrical conductivities of various waters and methanol;

FIG. 10 is an exemplary flow chart showing operation for discriminating an appropriate fuel in a fuel cell unit according to a second embodiment of the invention; and

FIG. 11 is an exemplary flow chart showing operation for discriminating an appropriate fuel in a fuel cell unit according to a third embodiment of the invention.

### DETAILED DESCRIPTION

Various embodiments according to the invention will be described hereinafter with reference to the accompanying drawings. In general, according to one embodiment of the invention, there is provided a fuel cell unit comprising: a unit body including an electromotive section which performs power generation operation; a fuel cartridge removably attached to the unit body and stored with a fuel; a fuel supply line through which the fuel is supplied from the fuel cartridge to the electromotive section; a fuel detecting section configured to detect a property of the fuel in the fuel supply line; and a control section which at least warns about the necessity of replacement of the fuel cartridge or stops the operation of the unit body if the property of the fuel detected by the fuel detecting section is different from a given property.

A fuel cell system according to a first embodiment of the present invention will now be described in detail with reference to the accompanying drawings.

The fuel cell system according to the present embodiment is provided with a fuel cell unit and an information processor, e.g., a notebook personal computer, which receives electric power supply from the fuel cell unit.

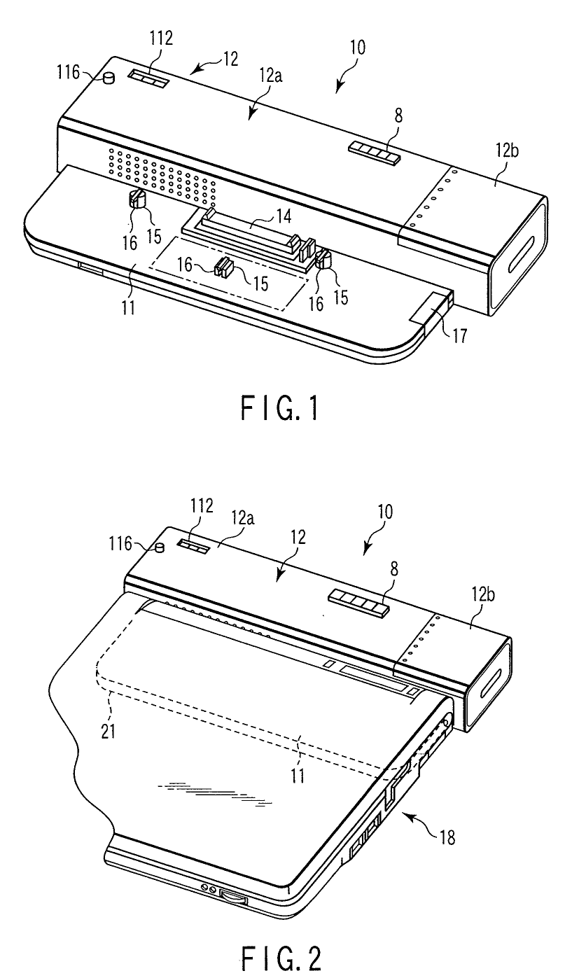

FIG. 1 is an external view showing a fuel cell unit 10, and FIG. 2 is an external view showing the fuel cell unit and an information processor 18 connected to it. As shown in FIG. 1, the fuel cell unit 10 is provided with a mounting platform 11 on which the rear part of the information processor is set and a unit body 12. The fuel cell unit body 12 is constructed as a direct-methanol fuel cell (DMFC) that uses a methanol solution as its fuel. As described later, the unit body 12 contains therein a DMFC stack for power generation based on an electrochemical reaction and various accessories for injecting into and circulating methanol and air that form the fuel in the DMFC stack.

The unit body 12 includes a unit case 12a, and a removable fuel cartridge is held in, for example, the left-hand end of the unit case. A part of the unit case 12a constitutes a detachable cover 12b that facilitates the fuel cartridge to be replaced with a new one.

A power generation setting switch 112 and a fuel cell operation switch 116 are provided on, for example, one end portion of the upper surface of the unit case 12a. A plurality of indicators 8 are arranged on the central part of the upper surface of the unit case 12a. They serve as indicating means that indicate the operating state of the fuel cell unit 10 and the necessity of replacement (error) of the fuel cartridge. Alternatively, a display may be provided as indicating means on the unit case 12a.

The power generation setting switch 112 is a switch that is preset by a user to allow or prohibit power generation in the fuel cell unit 10. For example, it may be composed of a slide-type switch. The fuel cell operation switch 116 is used, for example, to stop only the power generation in the fuel cell unit 10 without interrupting the operation of the information processor 18 while the processor 18 is being operated by electric power that is generated by the unit 10. In this case, the operation of the information processor 18 is continued by using power from a built-in secondary battery. For example, the operation switch 116 may be composed of a push switch.

The mounting platform 11 has a flat rectangular shape, extending horizontally from the unit case 12a so that the rear part of the information processor 18 can be placed on it. A docking connector 14 for use as a junction for connection with the processor 18 is provided on the upper surface of the platform 11. As shown in FIGS. 1 and 2, a docking connector 21 (mentioned later) for use as a junction for connection with the fuel cell unit 10 is provided on, for example, the rear part of the bottom surface of the processor 18. When the rear part of the information processor 18 is set on the mounting platform 11, the docking connectors 14 and 21 are connected mechanically and electrically to each other.

Positioning projections 15 and hooks 16 that constitute a locking mechanism are disposed on three spots of the mounting platform 11. The projections 15 and the hooks 16 individually engage engaging holes (not shown) in the rear part of the bottom surface of the information processor 18, thereby positioning and holding the information processor with respect to the platform 11. The platform 11 is provided with an eject button 17, which is used to unlock the locking mechanism in removing the processor 18 from the fuel cell unit 10.

The shape and size of the fuel cell unit 10 shown in FIGS. 1 and 2, the shape and position of the docking connector 14, and the like may be modified variously.

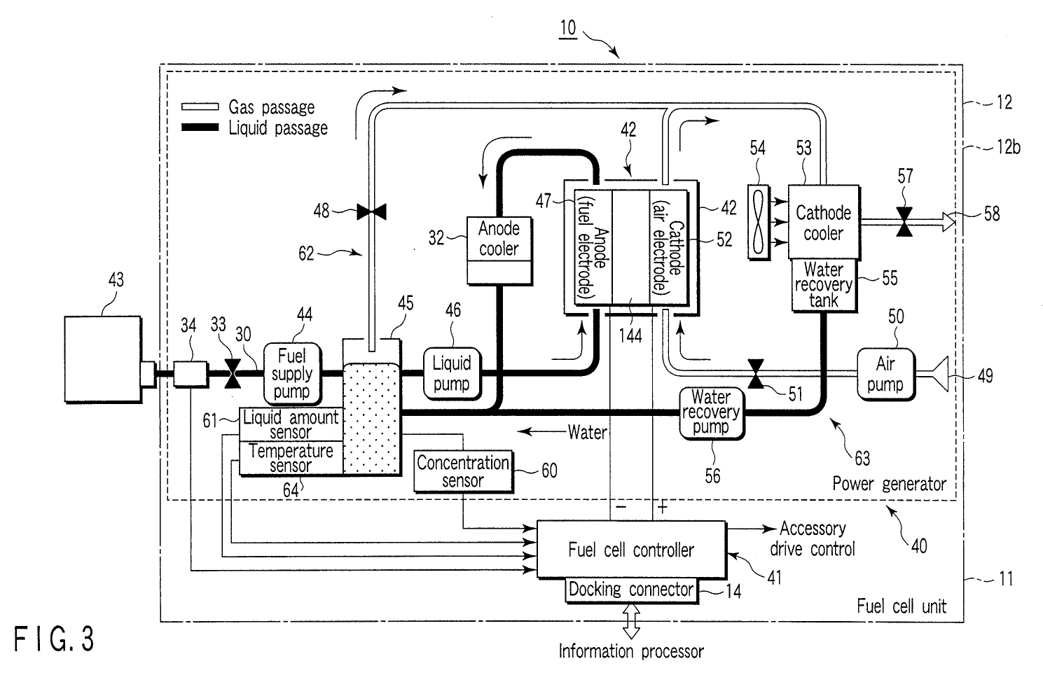

FIG. 3 is a system diagram showing the fuel cell unit 10 and illustrates detailed systems for the DMFC stack and accessories around it, in particular.

The fuel cell unit 10 is provided with a power generator 40 and a fuel cell controller 41 for use as control means for the unit 10. The controller 41 controls the operation of the generator 40, and besides, serves as a communication control section for communication with the information processor 18.

The power generator 40 is provided with a fuel cartridge 43 and a DMFC stack 42 that functions as an electromotive section. High-concentration methanol is stored as a liquid fuel in the cartridge 43. The cartridge 43 is removable from the unit body 12 so that it can be easily replaced with a new one when it is exhausted.

In a direct-methanol fuel cell, a crossover phenomenon must be reduced in order to improve the power generation efficiency. For this purpose, it is effective to dilute the high-concentration methanol and inject it into a fuel electrode 47 of the DMFC stack 42. To attain this, the fuel cell unit 10 uses a dilution/circulation system 62, and necessary accessories 63 are provided for the realization of the system 62.

The dilution/circulation system 62 is provided with a liquid passage through which the fuel and other fluids are run and a gas passage through which air and other gases are allowed to flow. The accessories 63 include ones provided in the liquid passage and others in the gas passage.

The liquid passage is provided with a fuel supply line 30 that extends from the fuel cartridge 43 to the DMFC stack 42. The accessories 63 in the fuel supply line 30 include a fuel supply pump 44 connected to an output portion of the cartridge 43, a mixing tank 45 connected to an output portion of the pump 44, and a liquid pump 46 connected to an output portion of the tank 45. An output portion of the pump 46 is connected to an anode (fuel electrode) 47 of the DMFC stack 42. An output portion of the anode 47 is connected to the mixing tank 45 through an anode cooler 32. Further, the fuel supply line 30 is provided with a fuel supply valve 33 between the fuel cartridge 43 and the fuel supply pump 44. The valve 33 serves to open and close the fuel supply line 30. Furthermore, a detector 34 is provided at the fuel supply line 30 between the valve 33 and the cartridge 43. The detector 34 serves to detect a property of the fuel that is supplied from the cartridge 43. The detector 34 used in the present embodiment is a conductivity sensor that detects the electrical conductivity of the fuel as a fuel property. Although the detector 34 should preferably be located near a supply port of the cartridge 43, it is only expected to be situated between the cartridge and the mixing tank.

The accessories 63 include a water recovery tank 55 that is disposed adjacent to a cathode cooler 53 (mentioned later). An output portion of the tank 55 is connected to a water recovery pump 56. An output portion of the pump 56 is connected to the mixing tank 45 by the liquid passage. The fuel cartridge 43, fuel supply pump 44, mixing tank 45, and liquid pump 46 constitute a fuel supply section that supplies the fuel to the DMFC stack 42.

The accessories 63 in the gas passage include an air pump 50 and the cathode cooler 53. The pump 50 is connected to a cathode (air electrode) 52 of the DMFC stack 42 through an air valve 51. The cooler 53 is connected to an output portion of the cathode 52. The mixing tank 45 is pipe-connected to the cathode cooler through a tank valve 48. The cathode cooler 53 is connected to an exhaust port 58 through an exhaust valve 57. The cooler 53 is provided with fins that condense steam effectively. A cooling fan 54 is located opposite the cooler 53.

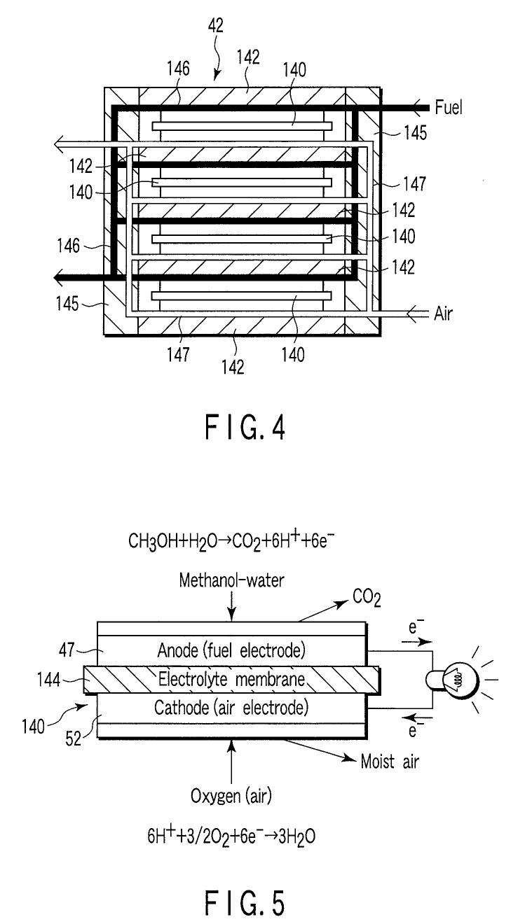

As shown in FIGS. 4 and 5, the DMFC stack 42, which functions as a cell laminate, includes a laminated structure and a frame 145 that supports the laminated structure. The laminated structure includes a plurality of, e.g., four, single cells 140 and five separators 142 in the form of rectangular plates, which are alternately stacked in layers. Each single cell 140 is provided with a membrane electrode assembly (MEA), which integrally includes the cathode 52 and the anode 47, each in the form of a rectangular plate composed of a catalyst layer and a carbon paper, and a substantially rectangular polymer electrolyte membrane 144 sandwiched between the cathode and the anode. The electrolyte membrane 144 is formed having an area larger than those of the cathode 52 and the anode 50.

Three of the separators 142 are stacked in layers, each between two adjacent single cells 140, while the other two separators are stacked individually at the opposite ends with respect to the stacking direction. The separators 142 and the frame 145 are formed having a fuel passage 146 for fuel supply to the anode 47 of each single cell 140 and an air passage 147 for air supply to the cathode 52 of the single cell.

The power generation mechanism of the power generator 40 of the fuel cell unit 10 will now be described along flows of the fuel and air (oxygen).

First, as shown in FIG. 3, the high-concentration methanol in the fuel cartridge 43 is supplied to the mixing tank 45 by the fuel supply pump 44. In the mixing tank 45, the high-concentration methanol is mixed with recovered water, low-concentration methanol (residue of a power generation reaction) from the anode 47, etc., and diluted, whereupon low-concentration methanol is produced. The low-concentration methanol is controlled so that a concentration of, e.g., 3 to 6% is maintained for high power generation efficiency. This concentration control may be achieved as the fuel cell controller 41 controls the amount of high-concentration methanol supplied to the mixing tank 45 by the fuel supply pump 44 in accordance with, for example, the result of detection by a concentration sensor 60. Alternatively, the concentration control may be realized by controlling the amount of circulating water in the mixing tank 45 by means of the water recovery pump 56 or the like.

The mixing tank 45 is provided with a liquid amount sensor 61 for detecting the amount of an aqueous methanol solution in the mixing tank 45 and a temperature sensor 64 for temperature detection. Results of detection by these sensors are delivered to the fuel cell controller 41 and used for the control of the power generator 40 and the like.

The aqueous methanol solution diluted in the mixing tank 45 is compressed by the liquid pump 46 and fed into the fuel passage 146 of the DMFC stack 42, through which it is injected into the anode 47 of each single cell 140. In the anode 47, as shown in FIG. 5, electrons are generated as the methanol is oxidized. Hydrogen ions (H+) generated by the oxidation reaction permeate the solid polymer electrolyte membrane 144 in the DMFC stack 42 and reach the cathode 52.

Carbon dioxide that is generated by the oxidation reaction at the anode 47, along with an unoxidized portion of the aqueous methanol solution, is cooled by the anode cooler 32 and then circulated again into the mixing tank 45. The carbon dioxide is gasified in the mixing tank 45, fed through the gas passage into the cathode cooler 53, and finally, discharged to the outside through the exhaust valve 57 and the exhaust port 58.

As shown in FIG. 3, on the other hand, air (oxygen) is introduced through an intake port 49 and compressed by the air pump 50 that constitutes an air supply section. Thereafter, it is fed through the air valve 51 into the air passage 147 of the DMFC stack 42, through which it is supplied to the cathode (air electrode) 52 of each single cell 140. At the cathode 52, reduction of oxygen (O²) advances, whereupon electrons (e⁻) from an external load and hydrogen ions (H⁺) and oxygen (O²) from the anode 47 produce water (H²O) in the form of steam. This steam is discharged from the cathode 52 and gets into the cathode cooler 53. In the cooler 53, the steam is cooled by the cooling fan 54 to water (liquid), which is temporarily stored in the water recovery tank 55. The recovered water is circulated into the mixing tank 45 by the water recovery pump 56, whereby the dilution/circulation system 62 for diluting the high-concentration methanol is formed.

As seen from the power generation mechanism of the fuel cell unit 10 based on the dilution/circulation system 62, the accessories 63, including the pumps 44, 46, 50 and 56, the valves 48, 51 and 57, the cooling fan 54, etc., are driven to extract electric power from the DMFC stack 42, that is, to start power generation. Thus, the aqueous methanol solution and air (oxygen) are injected into the DMFC stack 42, whereupon an electrochemical reaction advances to generate electric power. The electric power generated in the DMFC stack 42 is supplied to the information processor 18 through the fuel cell controller 41 and the docking connector 14. In stopping the power generation, on the other hand, the drive of the accessories 63 or the extraction of electric power from the DMFC stack 42 is stopped.

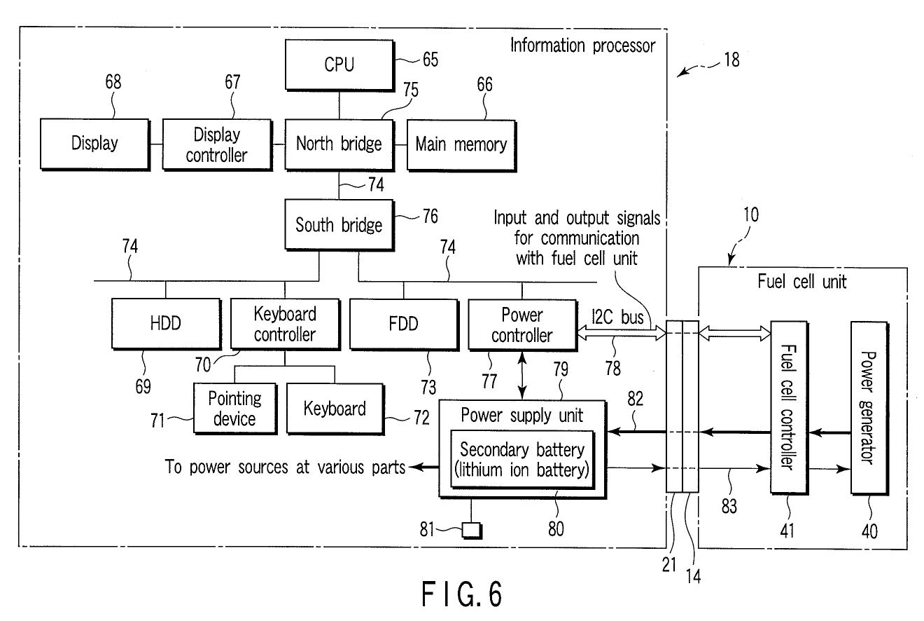

FIG. 6 shows a system configuration of the information processor 18 to which the fuel cell unit 10 according to the present invention is connected.

The information processor 18 comprises a CPU 65, main memory 66, display controller 67, display 68 for use as a display section, hard disc drive (HDD) 69, keyboard controller 70, pointing device 71, keyboard 72 as a input section, and FDD 73. The processor 18 further comprises a bus 74 that transfers signals between these components, devices called north and south bridges 75 and 76 for converting the signals transferred through the bus 74, and the like. Furthermore, a power supply unit 79 is disposed in the information processor 18, and a secondary battery 80, such as a lithium ion battery, is held in the unit 79. The power supply unit 79 is controlled by a power controller 77.

The CPU 65 serves to control the operation of the entire information processor 18, and it executes various programs for an operating system (OS), utility software including a power management utility, application software, etc., which are stored in the main memory 66.

A control-system interface and a power-system interface are provided as electrical interfaces between the fuel cell unit 10 and the information processor 18. The control-system interface is an interface for communication between the power controller 77 of the information processor 18 and the fuel cell controller 41 of the fuel cell unit 10. The communication between the processor 18 and the unit 10 through the control-system interface is made by means of a serial bus, such as an I2C bus 78.

The power-system interface is an interface for power transfer between the fuel cell unit 10 and the information processor 18. For example, electric power generated by the DMFC stack 42 of the power generator 40 is supplied to the information processor 18 through the fuel cell controller 41 and the docking connectors 14 and 21. The power-system interface also includes a power supply 83 from the power supply unit 79 of the processor 18 to the accessories 63 in the fuel cell unit 10.

DC source power, obtained by AC/DC conversion, is supplied to the power supply unit 79 of the information processor 18 through an AC adapter connector 81, whereby the processor 18 can be activated, and the secondary battery 80 can be charged.

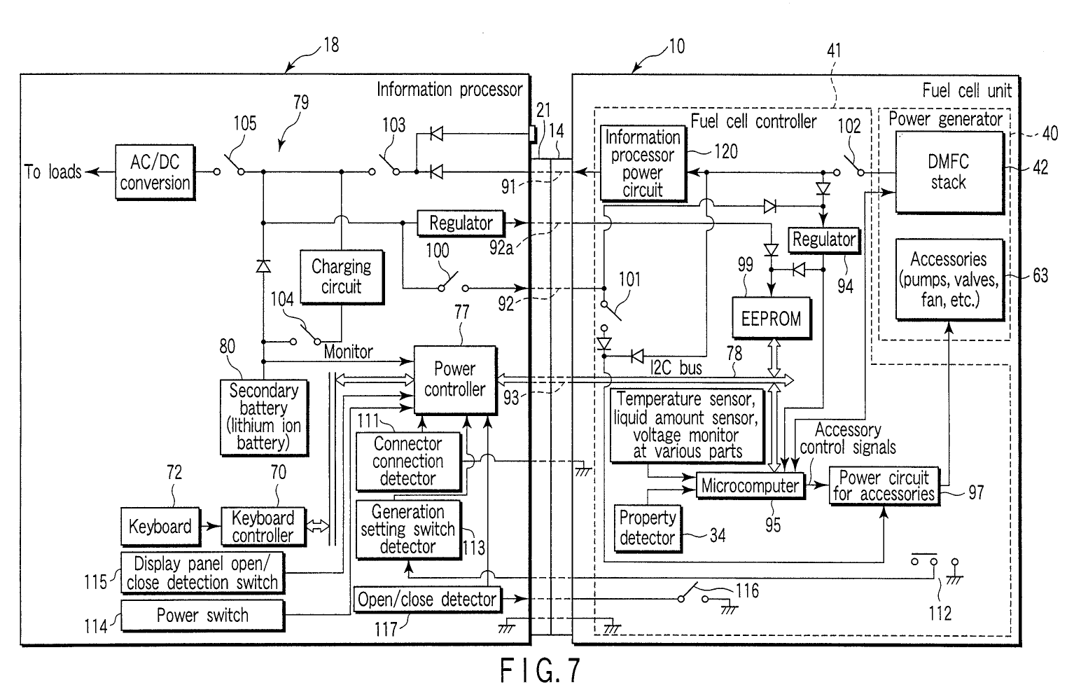

FIG. 7 is a configuration diagram showing connection between the fuel cell controller 41 of the fuel cell unit 10 and the power supply unit 79 of the information processor 18.

The cell controller 41 of the fuel cell unit 10 is provided with a microcomputer 95, a nonvolatile memory (EEPROM) 99 loaded with various data, a power circuit 97 for accessories, an information processor power circuit 120, etc. The fuel cell unit 10 and the information processor 18 are connected mechanically and electrically to each other by the docking connectors 14 and 21. The docking connectors 14 and 21 are provided with a first power terminal (output power terminal) 91 and a second power terminal (input power terminal for accessories) 92. Electric power generated by the DMFC stack 42 of the fuel cell unit 10 is supplied to the information processor 18 through the first power terminal 91. The second power terminal 92 is used to supply source power from the processor 18 to the microcomputer 95 of the fuel cell unit 10 through a regulator 94 and supply source power to the power circuit 97 for accessories through a switch 101. Further, the docking connectors 14 and 21 are provided with a third power terminal 92a through which source power is supplied from the processor 18 to the EEPROM 99.

Furthermore, the docking connectors 14 and 21 are provided with a communication input/output terminal 93 for communication between the power controller 77 of the information processor 18 and the microcomputer 95 of the fuel cell unit 10 or the writable EEPROM 99. The microcomputer 95 serves also as a detector for detecting the output power of the DMFC stack 42. The detected output power, e.g., an output current value in this case, is loaded into the EEPROM 99.

Referring now to FIG. 7, there will be described a basic flow of processing such that electric power generated by the DMFC stack 42 of the fuel cell unit 10 is supplied from the unit 10 to the information processor 18. Now let it be supposed that the secondary battery (lithium ion battery) 80 of the information processor 18 is charged with predetermined electric power and that all the switches shown in FIG. 7 are open.

Based on a signal output from a connector connection detector 111, the information processor 18 recognizes that it is connected mechanically and electrically to the fuel cell unit 10. This recognition is made as the connection detector 111 detects, based on a signal input thereto, for example, that it is grounded in the fuel cell unit 10 when the docking connectors 14 and 21 are connected to each other.

The power controller 77 of the information processor 18 determines whether the power generation setting switch 112 is set in a generation permitting mode or a generation prohibiting mode. In response to a signal input to a generation setting switch detector 113, for example, the detector 113 detects whether the power generation setting switch 112 is grounded or open, depending on the setting state of the switch 112. If the switch 112 is open, the power controller 77 concludes that the generation prohibiting mode is established.

When the information processor 18 and the fuel cell unit 10 are mechanically connected to each other by the docking connectors 14 and 21, source power is supplied from the processor 18 to the EEPROM 99, as a memory section of the fuel cell controller 41, through the third power terminal 92a. The EEPROM 99 is previously stored with status information on the fuel cell unit 10 and the like. The status information may include, for example, a parts code, serial number, or rated output of the fuel cell unit 10, detected output current values of the DMFC stack 42, detected data, such as the liquid amount, temperature, concentration, etc., detected by the various sensors, appropriate conductivity of the fuel, etc. The EEPROM 99 is connected to a serial bus, such as the I2C bus 78, and data stored in the EEPROM 99 can be read while the source power is being supplied to the EEPROM 99. The power controller 77 can read the status information from the EEPROM 99 through the communication input/output terminal 93 and load it into a built-in register or the like.

In this state, the fuel cell unit 10 is not performing power generation, and its interior is kept so that no source power than that for the EEPROM 99 is supplied.

If the user sets the power generation setting switch 112 in the generation permitting mode, the power controller 77 in the information processor 18 is enabled to read identification information stored in the EEPROM 99 in the fuel cell unit 10. Preferably, the power generation setting switch should be a slide switch or any other suitable switch that can be kept open or closed.

If it is concluded, based on the identification information read from the EEPROM 99 in the fuel cell unit 10, that the unit 10 connected to the information processor 18 is compatible with the processor 18, the power controller 77 closes a switch 100 that is attached to the processor 18. Thereupon, electric power from the secondary battery 80 is supplied to the fuel cell unit 10 through the second power terminal 92, and source power is supplied to the microcomputer 95 through the regulator 94. In this state, the switch 101 in the fuel cell unit 10 is open, and no source power is supplied to the power circuit 97 for accessories. Thus, the accessories 63 are not operating in this state.

However, the microcomputer 95, having already started operation, is ready to receive various control commands from the power controller 77 of the information processor 18. Further, the microcomputer 95 is ready to transmit power supply information of the fuel cell unit 10 to the processor 18.

When a generation start command is delivered from the power controller 77 to the fuel cell controller 41 in this state, the controller 41 having received this command closes the switch 101 under the control of the microcomputer 95, whereupon source power is supplied from the information processor 18 to the power circuit 97 for accessories. In response to accessory control signals transmitted from the microcomputer 95, at the same time, the controller 41 drives the accessories 63 in the power generator 40, that is, the pumps 44, 46, 50 and 56, valves 33, 48, 51 and 57, cooling fan 54, and the like. Further, the microcomputer 95 closes a switch 102 in the fuel cell controller 41.

In consequence, the aqueous methanol solution and air are injected into the DMFC stack 42 in the power generator 40, and power generation is started. Electric power generated by the DMFC stack 42 starts to be supplied to the information processor 18 through an information processor power circuit 120 in the fuel cell controller 41. Since the generated power output cannot instantaneously reach a rated value, however, a warm-up mode is maintained so that the rated value is reached.

The microcomputer 95 of the fuel cell controller 41 monitors, for example, the output voltage and temperature of the DMFC stack 42. When it concludes that a rated value is reached by the output of the stack 42, the microcomputer 95 opens the switch 101 of the fuel cell unit 10, thereby switching the source of power supply to the accessories 63 from the information processor 18 to the stack 42.

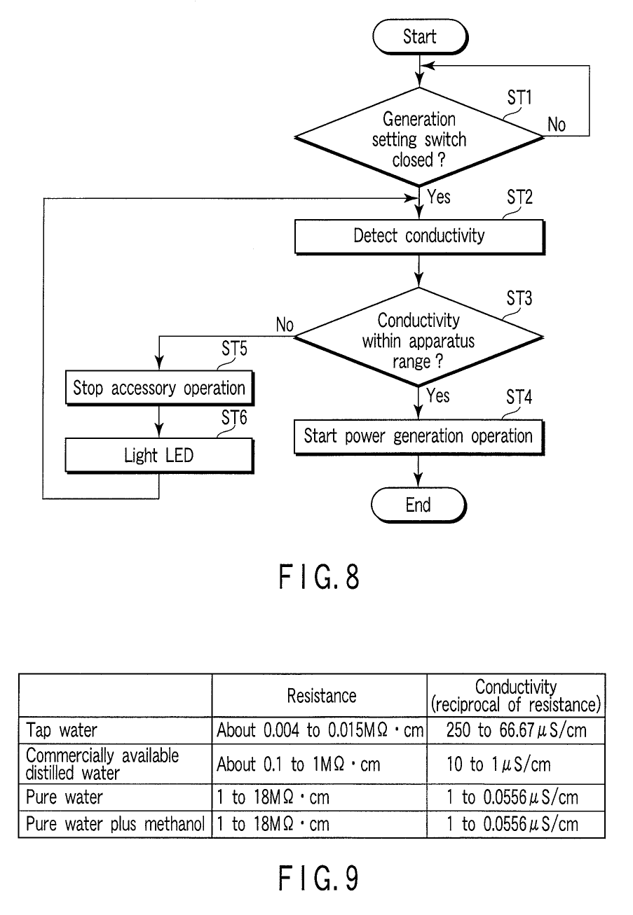

After the power generation setting switch 112 is closed, on the other hand, the fuel cell controller 41 determines whether or not a fuel supplied from the fuel cartridge 43 is appropriate. In other words, as shown in FIG. 8, the controller 41 determines whether or not the switch 112 is closed (ST1). If the switch 112 is closed, the controller 41 causes the property detector 34 to detect the conductivity of the fuel supplied from the cartridge 43 (ST2) and compares the detected conductivity and an appropriate range of conductivity stored in the EEPROM 99 (ST3).

FIG. 9 shows the respective resistances and conductivities (reciprocals of the resistances) of tap water, commercially available distilled water, pure water, and a mixture of pure water and methanol, for example. As seen from FIG. 9, tap water, commercially available distilled water, and pure water are different in conductivity. If a mixture of pure water and methanol is used as the appropriate fuel, for example, its conductivity ranges from 0.0556 to 1 μS/cm. If tap water or commercially available distilled water is mixed in place of pure water, however, the conductivity of the fuel is inevitably deviated from the appropriate range.

If the detected conductivity falls within the appropriate range of conductivity, the fuel cell controller 41 causes the power generator 40 to start power generation (ST4).

If the detected conductivity is deviated from the appropriate range of conductivity, the fuel cell controller 41 concludes that the fuel supplied from the fuel cartridge 43 is inappropriate and keeps the accessories 63 stopped (ST5). More specifically, the controller 41 stops the pumps 44, 46, 50 and 56, the cooling fan 54, and the like in the power generator 40 and keeps the valves 33, 48, 51 and 57 closed. Further, the controller 41 lights or flashes a desired LED 8 on the unit body 12, thereby indicating inappropriateness of the fuel to the user or warning the user about the necessity of replacement of the fuel cartridge 43 (ST6). When this is done, a message, such as “CHANGE FUEL CARTRIDGE”, may be displayed on the display on the unit body 12 or the display 68 of the information processor 18 as the LED 8 is lit or instead of lighting the LED.

When the fuel cartridge 43 is replaced with a new one such that an appropriate fuel is supplied, thereafter, the fuel cell controller 41 starts normal power generation operation of the power generator 40.

According to the fuel cell system provided with the fuel cell unit constructed in this manner, supply of an inappropriate fuel to the fuel cell unit can be prevented by detecting the properties of the fuel supplied from the fuel cartridge and determining whether or not the fuel is appropriate. Thus, reduction of the power generation capacity that is attributable to an inappropriate type, concentration, purity, and the like of the fuel can be avoided, and the various components can be prevented from being broken or damaged. Further, use of fake fuel cartridges that are wrongfully filled with cheap fuels can be avoided.

Thus, there may be provided a fuel cell unit with improved reliability that can prevent use of inappropriate fuels.

The following is a description of a fuel cell unit according to a second embodiment of the invention.

According to the second embodiment, a hydrogen ion concentration sensor for detecting the hydrogen ion concentration (pH) of a fuel is used as the fuel property detector 34 shown in FIG. 3.

In general, an alcohol, such as methanol, and water that are used for the fuel is neutral, and the hydrogen ion concentration of the fuel is about 7. The hydrogen ion concentration of distilled water or tap water, as well as that of pure water, is about 7. If a mixture of pure water and methanol is used as an appropriate fuel, therefore, either of the respective hydrogen ion concentrations of an appropriate fuel and an inappropriate fuel, which is based on a mixture of methanol and distilled water or tap water in place of pure water, is about 7. Thus, it is hard to detect the difference between the fuels.

According to the present embodiment, therefore, an appropriate fuel to be used, whose pH is deviated substantially from the neutral value or 7, is prepared by adding a high-pH basic substance or a low-pH acidic substance to a mixture of pure water and methanol. A fuel cartridge 43 that is filled with this fuel is regarded as an appropriate fuel cartridge. In this case, a basic substance is added to a pure water-methanol mixture to form an appropriate available fuel with pH of, for example, 10.

The fuel of this type is used as an appropriate fuel, and the hydrogen ion concentration of the fuel supplied from the fuel cartridge 43 is detected by means of the hydrogen ion concentration sensor. By doing this, it can be easily determined whether or not the detected fuel is appropriate.

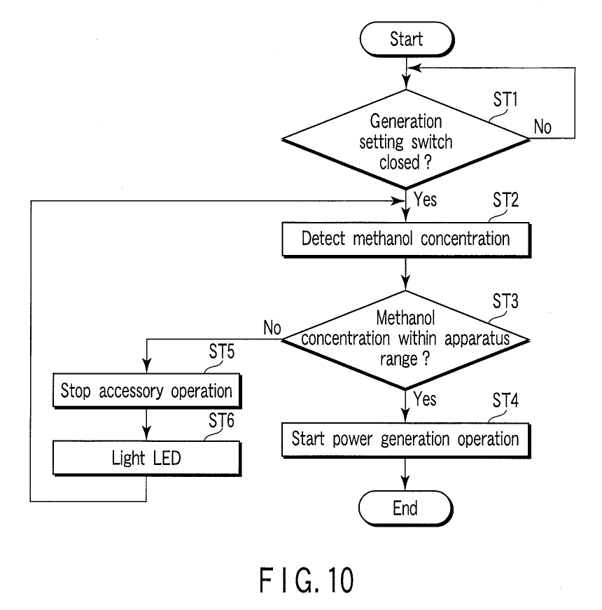

After a power generation setting switch 112 is closed, according to the second embodiment, a fuel cell controller 41 determines whether or not a fuel supplied from the fuel cartridge 43 is appropriate. In other words, as shown in FIG. 10, the controller 41 determines whether or not the switch 112 is closed (ST1). If the switch 112 is closed, the controller 41 causes the property detector 34 to detect the hydrogen ion concentration of the fuel supplied from the cartridge 43 (ST2) and compares the detected hydrogen ion concentration and an appropriate range of hydrogen ion concentration, e.g., pH 9 to 11, stored in an EEPROM 99 (ST3).

If the detected hydrogen ion concentration falls within the appropriate range of hydrogen ion concentration, the fuel cell controller 41 causes a power generator 40 to start power generation (ST4).

If the detected hydrogen ion concentration is deviated from the appropriate range of hydrogen ion concentration, the fuel cell controller 41 concludes that the fuel supplied from the fuel cartridge 43 is inappropriate and keeps accessories 63 stopped (ST5). More specifically, the controller 41 stops pumps 44, 46, 50 and 56, a cooling fan 54, and the like in the power generator 40 and keeps valves 33, 48, 51 and 57 closed. Further, the controller 41 lights or flashes a desired LED 8 on a unit body 12, thereby indicating inappropriateness of the fuel to the user or warning the user about the necessity of replacement of the fuel cartridge 43 (ST6). When this is done, a message, such as “CHANGE FUEL CARTRIDGE”, may be displayed on a display on the unit body 12 or a display 68 of an information processor 18 as the LED 8 is lit or instead of lighting the LED.

When the fuel cartridge 43 is replaced with a new one such that an appropriate fuel is supplied, thereafter, the fuel cell controller 41 starts normal power generation operation of the power generator 40.

Since other configurations of the fuel cell unit of the second embodiment are the same as those of the foregoing first embodiment, a detailed description thereof is omitted. The same functions and effects as those of the first embodiment can be also obtained from the second embodiment.

The following is a description of a fuel cell unit according to a third embodiment of the invention.

According to the third embodiment, a concentration sensor for detecting the concentration of a fuel is used as the fuel property detector 34 shown in FIG. 3.

If a mixture of pure water and methanol with a given concentration is used as an appropriate fuel, the fuel concentration, especially the methanol concentration, varies depending on the state of the mixture, the methanol and pure water generally having densities of 0.79 and 1, respectively.

According to the present embodiment, therefore, a fuel with a predetermined methanol concentration that is prepared by mixing pure water and methanol at a given mixture ratio is used as an appropriate fuel. A fuel cartridge 43 that is filled with this fuel is regarded as an appropriate fuel cartridge.

The fuel of this type is used as an appropriate fuel, and the methanol concentration of the fuel supplied from the fuel cartridge 43 is detected by means of the concentration sensor. By doing this, it can be determined whether or not the detected fuel is appropriate.

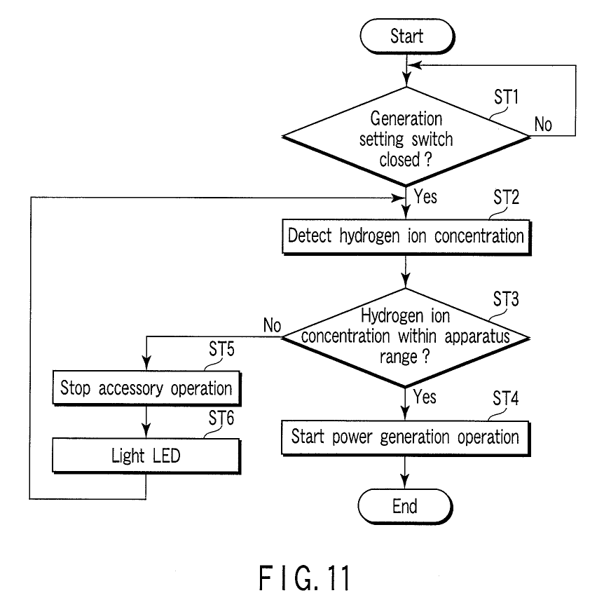

After a power generation setting switch 112 is closed, according to the third embodiment, a fuel cell controller 41 determines whether or not a fuel supplied from the fuel cartridge 43 is appropriate. In other words, as shown in FIG. 11, the controller 41 determines whether or not the switch 112 is closed (ST1). If the switch 112 is closed, the controller 41 causes the property detector 34 to detect the methanol concentration of the fuel supplied from the cartridge 43 (ST2) and compares the detected methanol concentration and an appropriate range of methanol concentration stored in an EEPROM 99 (ST3).

If the detected falls within the appropriate range of methanol concentration, the fuel cell controller 41 causes a power generator 40 to start power generation (ST4).

If the detected methanol concentration is deviated from the appropriate range of concentration, the fuel cell controller 41 concludes that the fuel supplied from the fuel cartridge 43 is inappropriate and keeps accessories 63 stopped (ST5). More specifically, the controller 41 stops pumps 44, 46, 50 and 56, a cooling fan 54, and the like in the power generator 40 and keeps valves 33, 48, 51 and 57 closed. Further, the controller 41 lights or flashes a desired LED 8 on a unit body 12, thereby indicating inappropriateness of the fuel to the user or warning the user about the necessity of replacement of the fuel cartridge 43 (ST6). When this is done, a message, such as “CHANGE FUEL CARTRIDGE”, may be displayed on a display on the unit body 12 or a display 68 of an information processor 18 as the LED 8 is lit or instead of lighting the LED.

When the fuel cartridge 43 is replaced with a new one such that an appropriate fuel is supplied, thereafter, the fuel cell controller 41 starts normal power generation operation of the power generator 40.

Since other configurations of the fuel cell unit of the third embodiment are the same as those of the foregoing first embodiment, a detailed description thereof is omitted. The same functions and effects as those of the first embodiment can be also obtained from the third embodiment.

While certain embodiments of the invention have been described, these embodiments have been presented by way of example only, and are not intended to limit the scope of the invention. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the property of the fuel to be detected is not limited to the embodiments described above but may be selected as required. According to the foregoing embodiments, moreover, high-concentration methanol is supplied from the fuel cartridge and mixed with water to be diluted in the mixing tank. Alternatively, however, the fuel cartridge may be stored with a low-concentration fuel previously diluted to a desired concentration such that the fuel can be supplied directly from the cartridge to the DMFC stack.

According to the embodiments described herein, both warning and interruption of the power generation operation are performed at the same time if it is concluded that the fuel is an inappropriate one. Alternatively, however, the arrangement may be such that at least one of these actions can be taken at a time.

Although the fuel cell unit is configured to be connected to the outside of the information processor, it may alternatively be contained in the information processor. The number of single cells in the DMFC stack is not limited to the foregoing embodiments but may be increased or reduced as required. The fuel cell system according to this invention is not limited to the personal computer described herein, but may also be applied to any other electronic devices, such as mobile devices, portable terminals, etc. The fuel cell may be a polymer electrolyte fuel cell (PEFC) or any other type than a DMFC.

What is claimed is:

1. A fuel cell unit comprising:
a unit body comprising an electromotive section configured to perform a power generation operation;
a fuel cartridge removably attached to the unit body and configured to store a fuel;
a fuel supply line through which the fuel is supplied from the fuel cartridge to the electromotive section;
a fuel detecting section configured to detect a property of the fuel in the fuel supply line; and
a control section configured to warn about the necessity of replacement of the fuel cartridge or to stop the operation of the unit body if the property of the fuel detected by the fuel detecting section is different from a given property.

2. The fuel cell unit according to claim 1, wherein the fuel detecting section comprises a detector configured to detect the electrical conductivity of the fuel, and wherein the control section is configured to compare the electrical conductivity of the fuel detected by the detector with a predetermined electrical conductivity.

3. The fuel cell unit according to claim 1, wherein the fuel detecting section comprises a detector configured to detect the hydrogen ion concentration of the fuel, and wherein the control section is configured to compare the hydrogen ion concentration of the fuel detected by the detector with a predetermined hydrogen ion concentration.

4. The fuel cell unit according to claim 3, wherein the fuel comprises a mixed solution of alcohol, water, and a basic or acidic additive.

5. The fuel cell unit according to claim 1, wherein the fuel comprises a mixed solution of alcohol and water, and wherein the fuel detecting section comprises a detector configured to detect the alcohol concentration of the fuel.

6. The fuel cell unit according to claim 1, wherein the unit body is provided with a supply mechanism that comprises a pump and a valve, and wherein the supply mechanism is configured to supply the fuel from the fuel cartridge to the electromotive section, and the control section is configured to stop the pump and close the valve if the property of the fuel detected by the fuel detecting section is different from the given property.

7. The fuel cell unit according to claim 1, wherein the unit body is provided with a display section for displaying the necessity of replacement of the fuel cartridge.

8. The fuel cell unit according to claim 1, wherein the unit body is provided with a mixing tank in which the fuel and water are mixed, and the fuel detecting section is located in a flow path between the fuel cartridge and the mixing tank.

9. The fuel cell unit according to claim 1, wherein the electromotive section is provided with a cell laminate that comprises a plurality of single cells stacked in layers on one another, each cell comprising an anode and a cathode opposed to one another, a fuel passage through which a fuel is supplied to the anode, and an air passage through which air is supplied to the cathode, each cell configured to generate electric power based on a chemical reaction.
